(19) United States
(12) Patent Application Publication
(10) Pub. No.: US 2014/0143835 A1
(43) Pub. Date: May 22, 2014

(54) Web-Based Digital Publishing Platform

(71) Applicant: MIGHTY VOX LLC, Palatine, IL (US)

(72) Inventors: Brian Brennan, Palatine, IL (US); Alison Shariatzadeh, Palatine, IL (US)

(73) Assignee: MIGHTY VOX LLC, Palatine, IL (US)

(21) Appl. No.: 13/679,548

(22) Filed: Nov. 16, 2012

(51) Int. Cl. G06F 17/00; G06F 15/16

(52) U.S. Cl. CPC G06F 17/00; G06F 15/16; H04L 63/08
USPC 726/4; 715/239; 709/204

(57) ABSTRACT

A method for providing a digital publication system includes on a first electronic computing device receiving a first document from a second electronic computing device. The first document is in a first format and comprises a plurality of pages. The first document is converted from the first format to a second format. The conversion generates a separate document in the second format for each page of the first document. Each separate document in the second format is stored in separate identifiable areas of memory of the first electronic computing device. A first request is received from the second electronic computing device to edit a first section of a page of the first document. One separate document in the second format is identified corresponding to the page in the first format to be edited. An action type is added to the first section of the identified separate document.

### BACKGROUND

With the proliferation of digital technology, many traditional newspaper readers want the option of reading traditional print publications online. To meet the needs of their customers, publishers typically need to create and support both print and web-based editions of their newspapers.

Typically, web-based editions have a different format than print editions. In online editions, content may be organized differently and may include links, videos and other information not available in the print editions. Web-based editions typically do not have the space to include large or full page ads that are commonly found in print editions. Creating two editions increases costs and may negatively affect paid subscriptions and advertising revenues.

### SUMMARY

Embodiments of the disclosure are directed to systems and methods for providing a digital publication system. On a first electronic computing device, a first document is received from a second electronic computing device. The first document is in a first format and comprises a plurality of pages. The first document is converted from the first format to a second format. The conversion generates a separate document in the second format for each page of the first document. Each separate document in the second format is stored in separate identifiable areas of memory of the first electronic computing device. A first request is received from the second electronic computing device to edit a first section of a page of the first document. One separate document in the second format is identified corresponding to the page in the first format to be edited. An action type is added to the first section of the identified separate document.

In another aspect, a first electronic computing device comprises a processing unit and a system memory. The system memory includes instructions that when executed by the processing unit cause the electronic device to: receive a first document from a second electronic computing device, the first document being in a first format and comprising a plurality of pages; convert the first document from the first format to a second format, the conversion generating a separate document in the second format for each page of the first document; store each separate document in the second format in separate identifiable areas of memory of the first electronic computing device; receive a first request from the second electronic computing device to edit a first section of a page of the first document; identify the separate document in the second format corresponding to the page in the first format to be edited; and add an action type to the first section of the identified separate document.

In yet another aspect, a computer-readable data storage medium comprising instructions that, when executed by a processing unit of a first electronic computing device, cause the first electronic computing device to: receive a first document from a second electronic computing device, the first document being in a first format and comprising a plurality of pages, the first format being a Portable Document Format (PDF); convert the first document from the first format to a second format, the second format being a Joint Photographic Experts Group (JPEG) format, the conversion generating a separate document in the second format for each page of the first document, each separate document being formatted using a Hypertext Markup Language (HTML) 5 markup language; store each separate document in the second format in a separate identifiable file folder of the first electronic computing device; receive a log-in request to the first electronic computing device from the second electronic computing device; transmit a publisher user interface to the second electronic computing device, the publisher user interface including a list of publications available for editing on the first electronic computing device; receive a first request from the second electronic computing device to edit a first section of a page of the first document; identify the separate document in the second format corresponding to the page in the first format to be edited; add an action type to the first section of the identified separate document, the action type creating an actionable effect on the first section of the identified separate document, the action type being one of a hyperlink, a photo, a slide show, and advertisement and a video; receive a log-in request to the first electronic computing device from a third electronic computing device; transmit a reader user interface to the third electronic device, the reader user interface including an interactive map of a geographic area, the interactive map of the geographic area providing names of publications that are available in a plurality of sub-areas of the geographic area; receive from the third electronic computing device a request for the first document; determine the identifiable file folder for each of the separate documents that corresponds to the first document; use a caching engine to obtain the separate documents from the identifiable file folders, the caching engine comprising a web service; send the obtained separate documents to the third electronic computing device; receive social networking information from the third electronic computing device; store the social networking information on the first electronic computing device; receive a request for the social networking information from a fourth electronic computing device; and send the social networking information to the fourth electronic computing device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a web-based digital publishing platform.

FIG. 2 shows example modules of a reader website.

FIG. 3 shows example modules of a publisher website.

FIG. 4 shows example modules of a portal website.

FIG. 5 shows an example user interface screen for the reader website of FIG. 1.

FIG. 6 shows another example user interface screen for the reader website of FIG. 1.

FIG. 7 shows an example user interface screen when a publication is selected on the user interface screen of FIG. 6.

FIG. 8 shows an example user interface screen for the publisher website of FIG. 1.

FIG. 9 shows an example details screen for the user interface screen of FIG. 8.

FIG. 10 shows an example editions screen for the user interface screen of FIG. 8.

FIG. 11 shows an example edit hotspots screen for the editions screen of FIG. 10.

FIG. 12 shows an example action type screen for the edit hotspots screen of FIG. 11.

FIG. 13 shows an example portals screen for the portal website of FIG. 1.

FIG. 14 shows a flowchart for a method for uploading a document to the publisher website of FIG. 1.

FIG. 15 shows a flowchart for a method for editing a document that has been uploaded to the publisher website of FIG. 1.

FIG. 16 shows a flowchart for reviewing a publication on the reader website of FIG. 1.

FIG. 17 shows example physical components of a web server computer of FIG. 1.

### DETAILED DESCRIPTION

The present disclosure is directed to systems and methods for a web-based digital publishing platform. The web-based digital publishing platform permits the publication of a web-based edition of a publication using a format similar to what is used in a print edition. In addition, the web-based digital publishing platform permits actionable effects, such as links, videos, photo galleries, etc. to be embedded in the publication content. In examples, the publication may be a newspaper, a magazine, a book or a catalogue. Other examples of publication are possible. The web-based digital publishing platform is accessible from a variety of electronic devices including desktop computers, laptop computers, tablet computers, smartphones, etc.

The web-based digital publishing platform includes a hosting portion and a reader portion. The hosting portion permits publishers to upload digital editions of the publication to the web-based digital publishing platform. Each digital edition is typically uploaded in a Portable Document Format (PDF) format. After uploading, a conversion process converts each PDF into a series of Joint Photographic Expert Group (JPEG) images. An editor can then be used to add actionable effects such as links, photos, videos, etc. to one or more of the JPEG images to produce a digital publication. When ready, the digital publication is made available for viewing.

The reader portion permits a user to view the digital publication via a web browser or on a handheld electronic device such as a tablet computer or smartphone. As discussed later herein, the reader portion also includes support for social media.

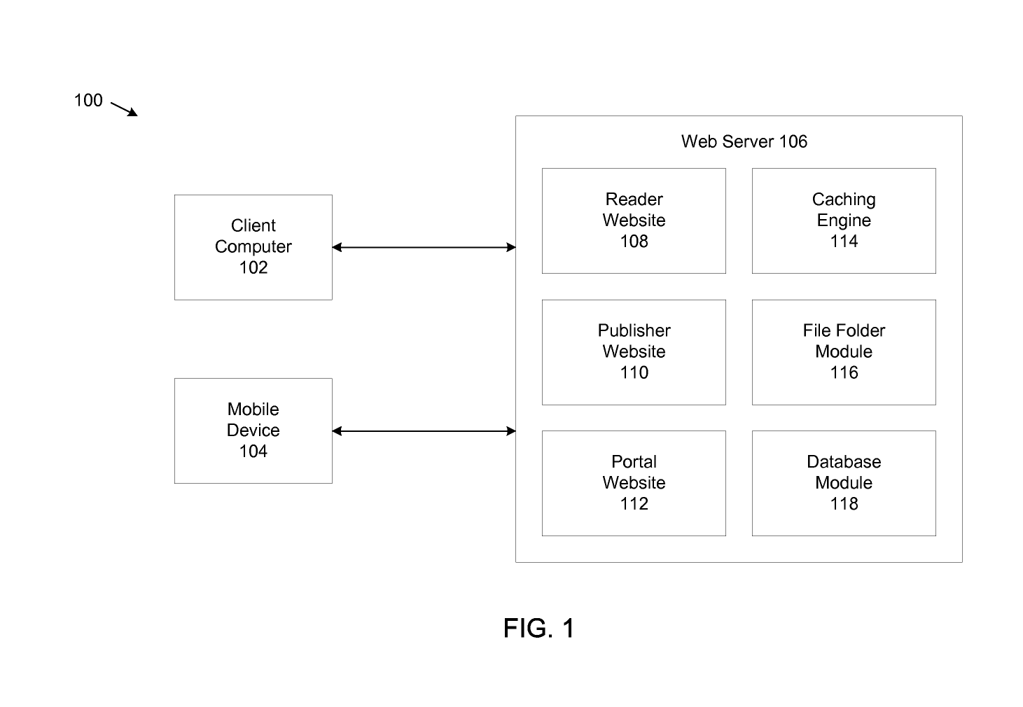

FIG. 1 shows an example system 100 that supports a web-based digital publishing platform. The example system 100 includes a client computer 102, a mobile computer 104 and a web server computer 106. More than one client computer, mobile computer and web server computer may be used. The client computer 102 is typically a desktop computer or a laptop computer. The mobile computer 104 is handheld device such as a tablet computer or a smartphone.

The example web server computer 106 includes a reader website 108, a publisher website 110, a portal website 112, a caching engine 114, a file folder module 116 and a database module 118.

The example reader website 108 is hosted on web server computer 106 and is accessible over the Internet from client computer 102 and mobile computer 104. In examples, the reader website 108 may be hosted on a different computer than web server computer 106. The reader website 108 permits a user to access one or more digital publications made available on the reader website 108.

The example publisher website 110 is also hosted on web server computer 106 and is accessible over the Internet from client computer 102 and mobile computer 104. In examples, the publisher website 110 may be hosted on a different computer than web server computer 106. The publisher website 110 permits a publisher to upload PDF editions of a publication and to edit converted editions of the publication as needed. As discussed, each uploaded PDF edition of the publication is converted into one or more JPEG images and made available for editing on the publisher website 110.

The example portal website 112 is also hosted on web server computer 106 and is accessible over the Internet from client computer 102 and mobile computer 104. In examples, the portal website 112 may be hosted on a different computer than web server computer 106. The portal website 112 is a website on which reader and publisher account and statistics information may be accessed. In addition, the portal website 112 may provide access to email templates, discussion groups and links to other web pages, etc.

The example caching engine 114 is a web service that processes the conversion of PDFs to JPEG images and that processes reader requests for JPEG images. The caching engine 114 uses a dynamic link library (DLL) to convert uploaded PDFs to JPEG images. Typically, each page of a PDF is converted into a separate JPEG image. In examples, each JPEG image is stored in the HTML 5 format, although other formats may be used. The caching engine also speeds up reader requests for display of publication pages, as explained later herein. In some examples, the caching engine 114 may be located on a different computer than web server computer 106.

The example file folder module 116 stores each JPEG image in a separate file folder on the web server computer 106. In JPEG image is stored at three different resolution levels, a regular level and two zoom levels. In addition, each file folder includes a reader thumbnail image, and a hot spot editor thumbnail image. Further, each file folder corresponding to page 1 of a PDF also includes a thumbnail image for the reader and a thumbnail image for the publisher.

The example database module 118 stores a backup copy of each PDF and of each JPEG image. In examples, the database module 118 may be located on a different computer than web server computer 106.

The conversion of each page of a PDF into a separate JPEG image and the storing of each JPEG image in a file folder results in faster processing times than if the PDF was stored without conversion or if the PDF or the JPEG images were stored directly in a database. Instead of loading an entire PDF, only the pages needed for viewing need to be loaded, thus reducing loading time. Further, because file access from a file folder is typically faster that file access from a database, the caching engine 114 speeds up processing time for display of publication pages.

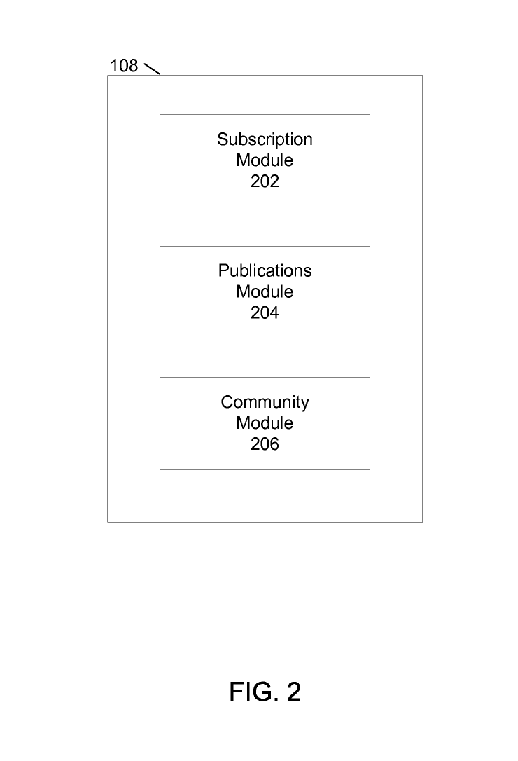

FIG. 2 shows example modules of the reader website 108. The example modules of the reader website 108 include a subscription module 202, a publications module 204 and a community module 206. The example subscription module 202 provides access to publications for a user. Access may be provided to publications for which the user has a subscription and publications that user selected for reading that are free. Current and previous editions of the subscribed to and free publications are available to the user. In addition, a section of user favorites may be included for quick view purposes. The subscription module 202 may also provide news feeds of interest to the user.

The example publications module 204 permits the user to select one more publications from different geographical areas in the United States of America. In examples, the publications module 204 may present an interactive map of the United States to the user. When the user moves a mouse over a state, the name of the state is displayed. When the state is selected, a list of publications available in the state is displayed for the user. If any of the publications require a subscription, the user may click on a subscription box and subscribe to the publication.

The example community module 208 provides social networking information to the user. The social networking information may include the names of friends, groups, events, discussions and other social networking information. The community module 208 permits a user to start a discussion, create a group and create an event. The community module 208 also may permit a user to access an email inbox, edit a profile and access photos and videos. Other functionality of the community module 208 may be provided.

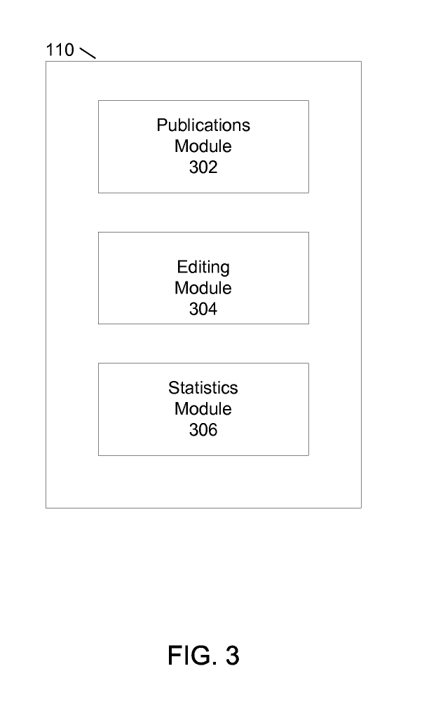

FIG. 3 shows example modules of the publisher website 110. The example publisher website includes a publications module 302, an editing module 304 and a statistics module 306. The example publications module 302 processes the uploading and organization of PDF files on the publisher website 110. As each publication is uploaded, each page of the publication is converted to a JPEG image. After each publication is uploaded, the publisher can select geographical areas, typically cities and states, where the publication may be available for viewing. The geographical areas correspond to an interactive map of the United States that may be accessed via readers. The publisher can also select how frequently editions of the publication occur and whether the publication is free or requires a subscription.

The example editing module 304 provides a hotspot editor for adding actionable effects to uploaded sections of the publication. The editing module permits a user to select one or more areas of a page of the publication and add an action type to the area. An action type provides an actionable effect when viewing the page of the publication. Example action types are links to websites, photos, photo galleries, emails, articles, advertisements and video. Other action types are possible. For example, the user may highlight the name of a product, for example an automobile, and select a photo of the automobile or a video related to the automobile. When a reader views the page of the publication and moves a mouse over the product name, the user may select the photo or video for viewing. In examples, the editing module 304 permits selection of an underline (similar to a hyperlink) or an icon to appear at the page area for the action type. The underline or icon makes it easier for a reader to see that the action type is available for viewing.

The example statistics module 306 compiles statistics related to the publications made available on the publisher website 110. Example statistics include the number of times a publication has been viewed, the number of different viewers who accessed the publication, a date for the last time the publication was viewed, etc. Other types of statistics are possible.

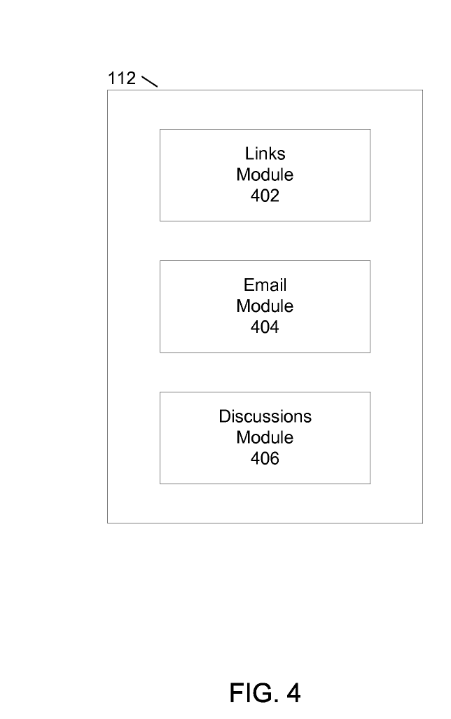

FIG. 4 shows example modules of the portal website 112. The example portal website 112 includes a links module 402, an email module 404 and a discussions module 406. The example links module 402 provides links to the reader website 108 and to the publisher website 110. The links module 402 provides icons for a reader website and a publisher website. When a user selects the icon for the reader website, the links module 402 provides a login screen for the reader website 108. When the user selects the icon for the publisher website, the links module 402 provides a login screen for the publisher website 110.

The example email module 404 provides email template management for the portal website 112. The email module 404 provides a list of available email templates and supports the editing of existing email templates and the creation of new email templates.

The example discussions module 406 provides a list of discussion categories that readers can choose. Example discussion categories include different types of sports and news. When a reader chooses a discussion category, the reader can start a new discussion thread for a discussion category or respond to an existing discussion thread.

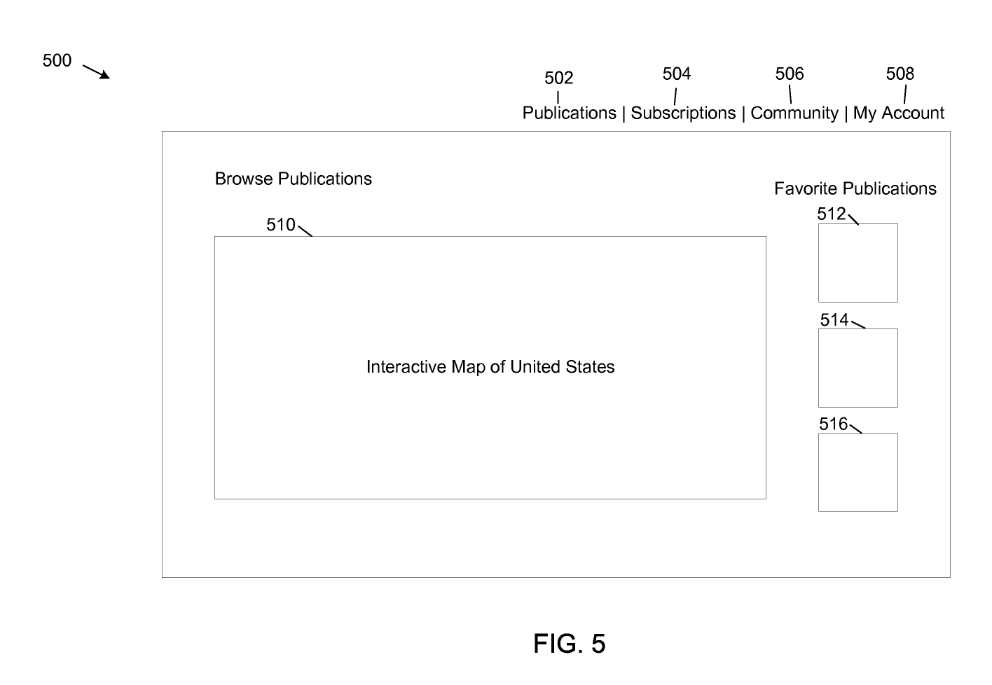

FIG. 5 shows an example user interface screen 500 rendered on a user device when the user accesses the reader website 108. As discussed, the user device may be a client computer or a handheld device such as a tablet computer or a smartphone. The user interface screen 500 provides a way for a reader to browse and select publications available for viewing. The user interface screen 500 includes tabs for selections of publications 502, subscriptions 504, community 506 and my account 508. When the publications 502 tab is selected, the example user interface screen 500 is rendered.

The user interface screen 500 includes an interactive map 510 of the United States. When a user moves a mouse over a state, the state is highlighted, typically in reverse video. When a highlighted state is selected, publications available in that state are displayed. The publications are typically newspapers, but may include other publication types, such as magazines or books. In examples, a selection box permits the user to select a publication for viewing. When the publication is selected, an icon 512 representing the publication appears on the user interface screen 500 to indicate that the publication is selected.

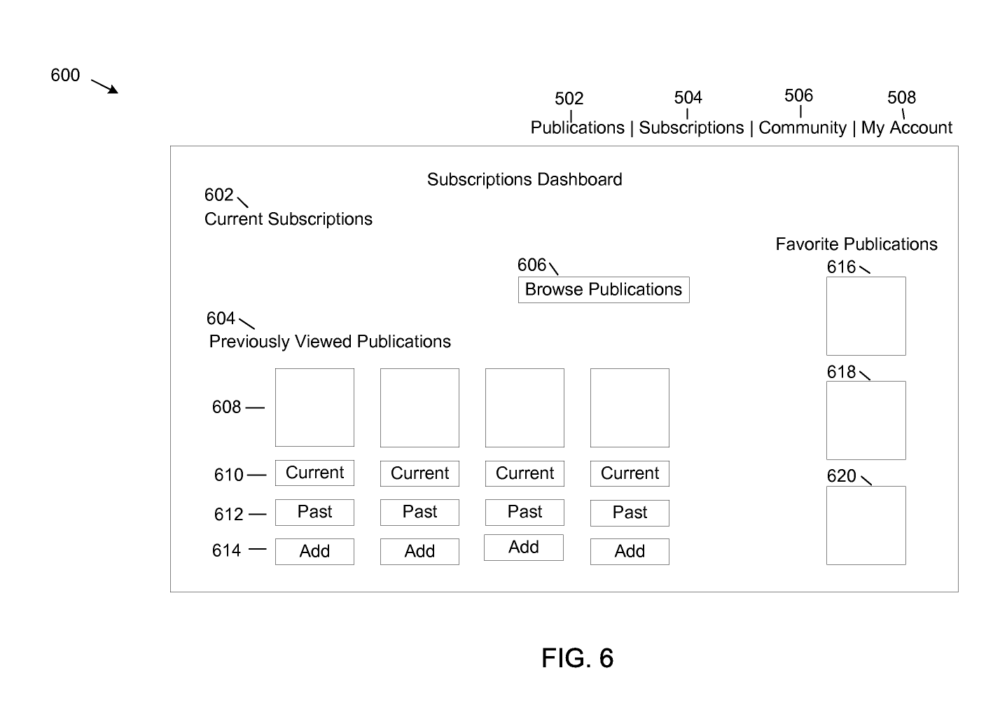

FIG. 6 shows another example user interface screen 600 for the reader website 108. The example user interface screen 600 is rendered on the user device when the subscriptions 504 tab is selected. The user interface screen 600 is a subscriptions dashboard, showing current subscriptions and previously viewed publications for the user. In this example, there are four previously viewed publications. A thumbnail is displayed for each previously viewed publication. Buttons are provided for displaying current and past publications and for adding a publication to a list of favorite publications.

For example, icon 608 represents a first publication. When icon 610 is selected, a current edition of publication 608 is displayed. When icon 612 is selected, thumbnails of past editions of publication 608 are displayed. When icon 614 is selected, publication 608 is added to a list of favorite publications. The example user interface screen 600 shows icons 616, 618 and 620 for current favorite publications. In addition, the user interface screen 600 includes a button 606 for browsing publications. When button 606 is selected, the user interface screen 500 is rendered.

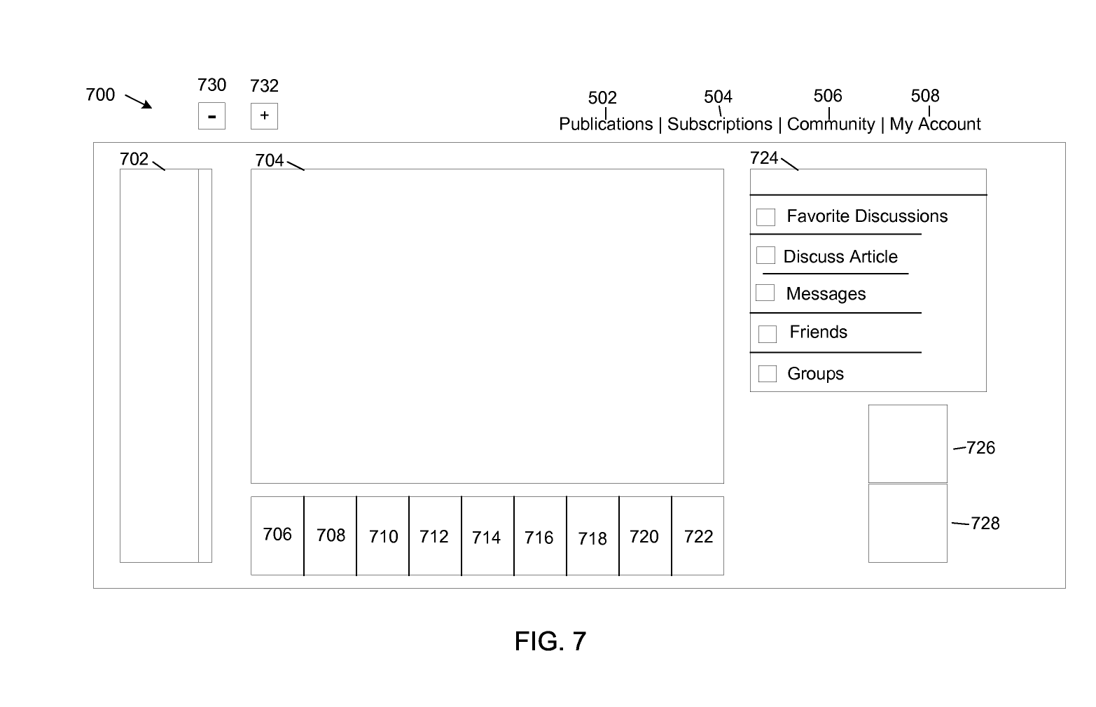

FIG. 7 shows an example user interface screen 700 rendered when a publication, for example publication 608, is selected. The example user interface screen 700 includes an area 704 that displays a page, typically the first page, of publication 608. In addition, the user interface screen 700 includes thumbnails for each page of publication 608. For example thumbnails 706-722 each represent a page of publication 608. Clicking on one of the thumbnails 706-722 displays the page associated with the thumbnail in the area 704. The user interface screen also includes a table of contents 702 listing all pages in publication 608. Selecting a page of the table of contents 702 also displays the page in area 704.

When a page is displayed in area 704, the page is displayed in a normal resolution size, for example 100 percent. The page can be zoomed to a first higher resolution by clicking an increase resolution button 732. Clicking the increase resolution button a second time zooms the page to a second higher resolution. Clicking a decrease resolution button 730 zooms the page in to a previous resolution level. When the page is displayed in a higher resolution, the entire page is not displayed in the area 704. Moving a mouse within area 704 permits hidden sections of the page to come into view.

The user interface screen 700 also includes an area 724 for social networking. A user can select categories like favorite discussions, discuss article, messages, friends and groups to bring up screens appropriate for the selected category. Other categories are possible. The user interface screen 700 also includes a newsfeed area, for example displaying newsfeeds 726 and 728.

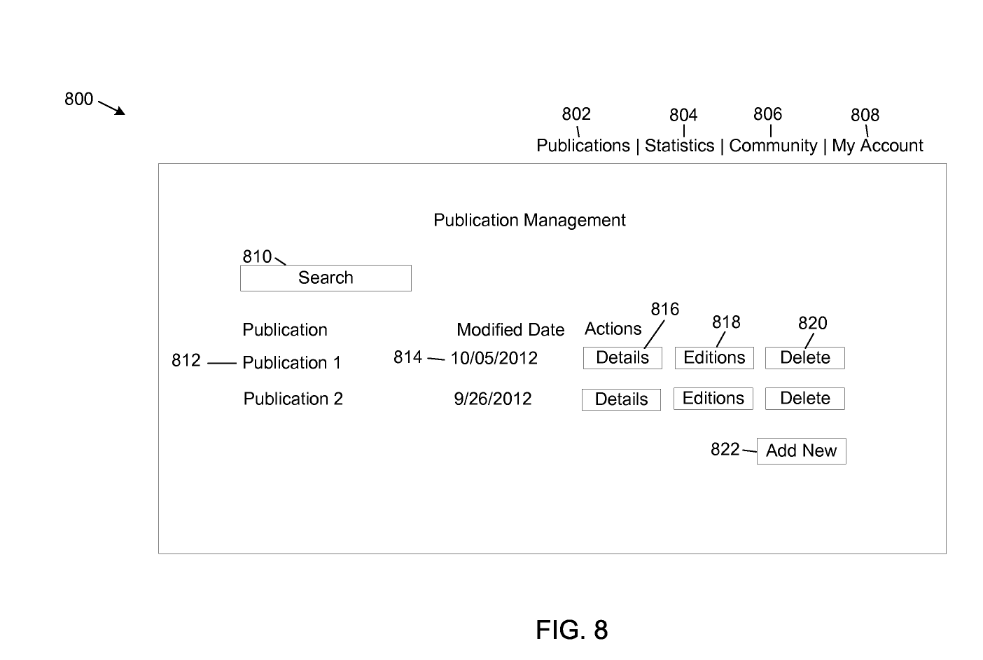

FIG. 8 shows an example user interface screen 800 rendered on a user device when the user accesses the publisher website 110. The user interface screen includes a list of all publications uploaded from a publisher. For example, the user interface screen 800 lists publication 1 and indicates that publication 1 was modified on Oct. 5, 2012. For each listed publication, the user interface screen provides a details button, an editions button and a delete button. The details button displays a details screen, the editions button activates a hotspot editor and the delete button deletes the publication from the user interface screen 800. For example details button 816 brings up a details screen for publication 1, editions button 818 activates the hotspot editor for publication 1 and delete button 820 deletes publication 1 from user interface screen 800.

The example user interface screen 800 also includes a search button 810 and an add-new button 822. The search button 810 permits searching for uploaded publications. The add-new button 822 permits uploading publications.

Additional controls include a publications tab 802, a statistics tab 804, a community tab 806 and a my-account tab 808. The user interface screen 800 is displayed when the publications tab 802 is selected. A screen displaying statistics is displayed when the statistics tab 804 is selected. Example statistics include viewing statistics for each publication, including a total number of times a publication is viewed, the number of different users viewing the publication, the last time the publication was viewed, etc. Selection of the community tab 806 brings up a community screen (not shown) where a user can start a discussion, respond to a discussion, create groups, create events, view friend lists, view photos, check email and other similar social networking activities. Selection of my-account tab 808 brings up a screen (not shown) with information about a user's account, such as name, address, user ID, password, photo, friends, etc.

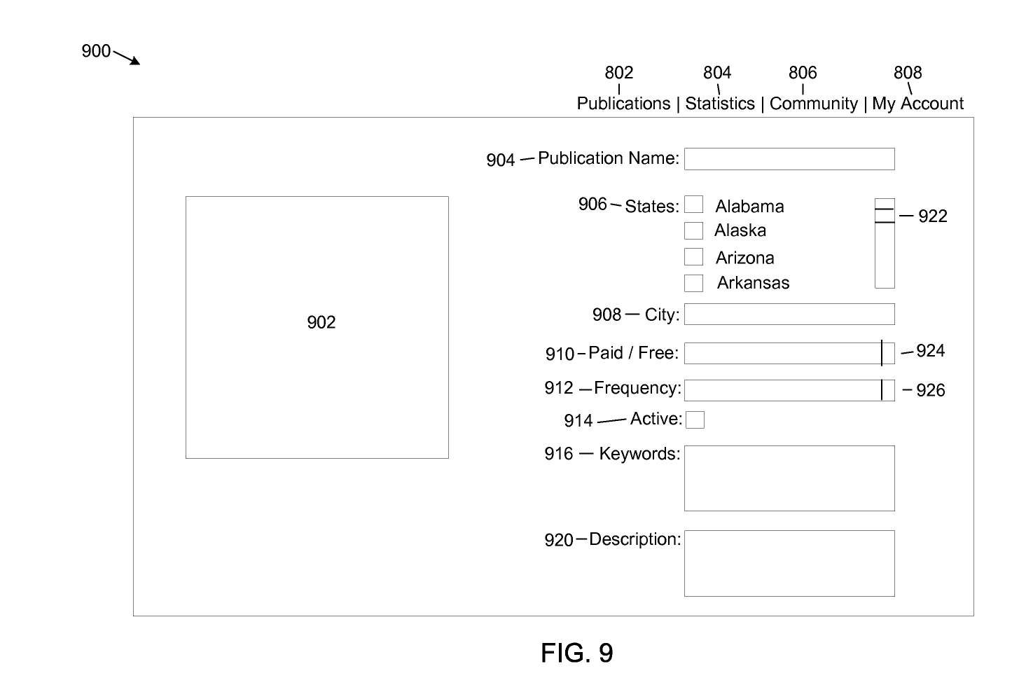

FIG. 9 shows an example details screen 900. The example details screen 900 is displayed when a details button, for example details button 816 is selected on publisher website 110 user interface screen 800. The details screen 900 shows a page 902, typically the first page of a publication, for example publication 1, corresponding to the details button selected. The details screen 900 includes a textbox 904 indicating the name of the publication, for example publication 1. The details screen 900 also includes checkboxes 906 corresponding to each state in which the publication is available on the interactive map 510 on the user interface screen 500.

Other information provided on the details screen 900 includes a name of a city 908 in which the publication is made available, a dropdown box 910 indicating whether the publication is paid or free, a dropdown box 912 indicating a frequency of publication, typically daily or weekly, a checkbox 914 indicating whether the publication is active and available for viewing on the reader website 108, one more keywords 916 that can be used when searching for the publication and a description 920 of the publication. The city 908 may be entered in lieu of checking one of the state checkboxes 906. The active checkbox 914 is checked when the publisher completes any edits to the publication and enables the publication for viewing on the reader website 108. The details screen 900 also includes the publications tab 802, the statistics tab 804, the community tab 806 and my-account tab 808.

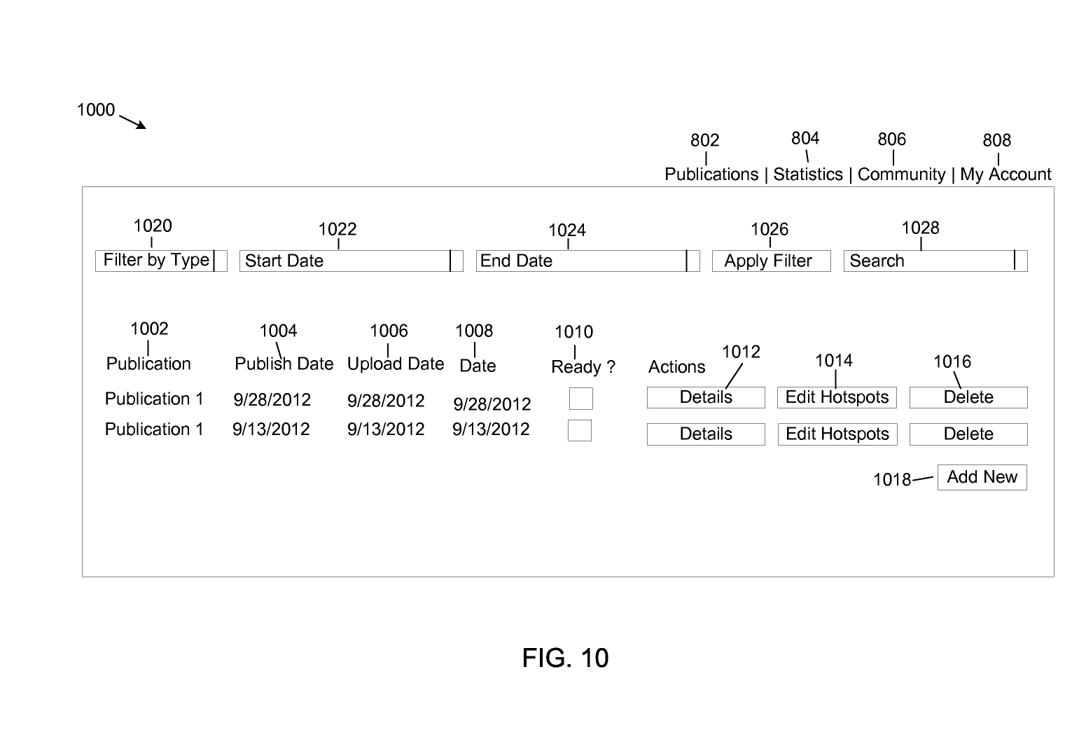

FIG. 10 shows an example editions screen 1000. The example editions screen 1000 is displayed when an editions button, for example editions button 818 is selected on the publisher website 110 user interface screen 800. The example editions screen provides a means for a publisher to edit an edition of a publication and add action types such as hyperlinks, photos, videos, etc. to the edition of the publication.

The editions screen 1000 includes a publication column 1002 for listing available editions of a publication, a publish date column 1004 for listing the publication date of the edition, an upload date column 1006 for listing a date at which the edition was uploaded to the publisher website 110, a date column 1008 at which changes were last made to the edition and an checkbox column 1010 indicating whether the edition is ready for publication. For each edition, the editions screen 1000 also includes three buttons corresponding to actions that a user can take. For example, for the publication 1 edition with a publication date of Sep. 28, 2012, the editions screen 1000 includes a details button 1012, an edit hotspots button 1014 and a delete button 1016.

Selection of details button 1012 displays a screen (not shown) that includes statistics for the edition, including the number of time the edition has been viewed, the number of unique viewers and the number of hotspots clicked. Selection of the edit hotspots button 1014 displays a screen that permits hotspots to be selected on a page of the edition and that permits action types such as hyperlinks, photos and videos to be added to a selected hotspot. Selection of the delete button 1016 causes the edition to be deleted from the editions screen 1000.

The editions screen 1000 also includes filtering capability for the editions listed. Included is a filter by type drop-down box 1020 that permits a filter type, a start date 1022 and an end date 1024 to be selected. Filter types include a publish date, an upload date, and a modified date. The start date 1022 represents an editions date from which a search is to start and the end date 1024 represents an editions date from which a search is to end. Also included is an apply filter button for applying the entered filtering criteria and a search button 1028 for initiating a search based on the entered filtering criteria. Results from the search are displayed in columns 1002-1010 and include details, edit hotspots and delete buttons for each search result. The editions screen 1000 also includes the publications tab 802, the statistics tab 804, the community tab 806 and my-account tab 808.

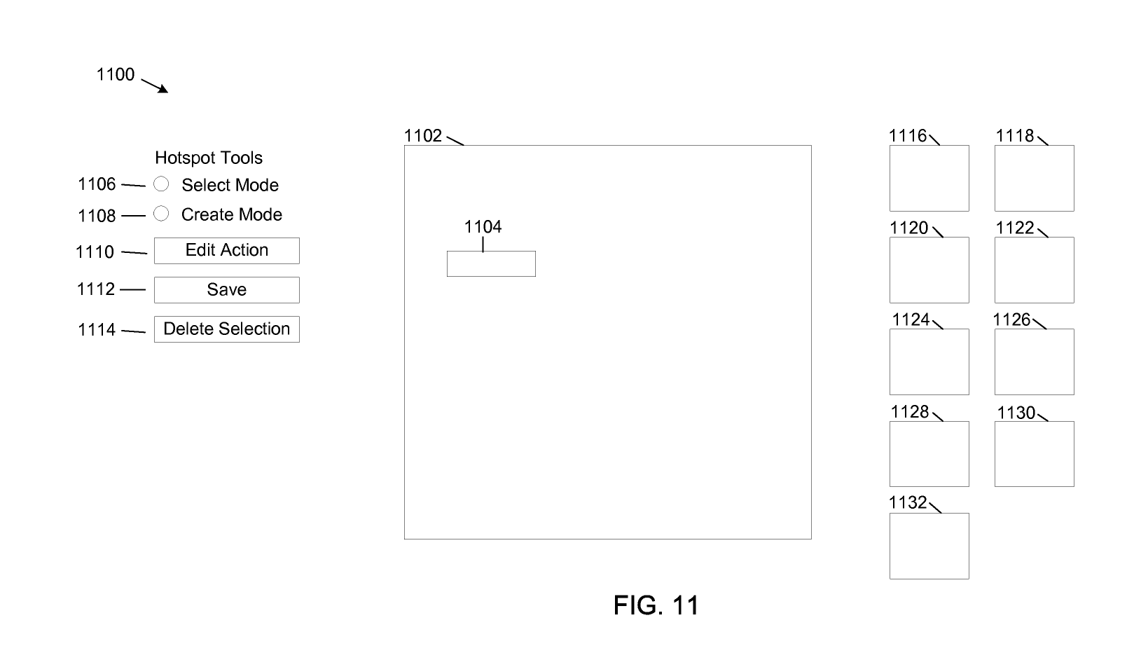

FIG. 11 shows an example edit hotspots screen 1100. The example edit hotspots screen 1100 is displayed when an edit hotspots button, for example edit hotspots button 1014 is selected on the editions screen 1000. The example edit hotspots screen 1100 includes a page 1102 of the selected edition to be edited. The page initially corresponds to the first page of the edition. The edit hotspots screen 1100 also includes thumbnails 1116-1132 corresponding to pages of the selected edition to be edited. Selecting one of the thumbnails 1116-1132 displays a page corresponding to the thumbnail in the page 1102 to be edited.

The edit hotspots screen 1100 also includes hotspot tools including a select mode 1106 radio button, a create mode 1108 radio button, an edit action button 1110, a save button 1112 and a delete selection button 1114. When a user wishes to edit a section of a page, the user selects the create mode 1108 radio button. After the create mode 1108 radio button is selected, the user drags a mouse to the section of the page. In examples, by left clicking the mouse, the user activates a rectangular box which can be sized to fit around the area of the page to be edited, for example to fit around a word, a series of words, a photo, etc. In examples, the rectangle is a color, for example red, that indicates that the section of the page is being edited. The user then selects the save button 1112. After the user selects the save button 1112, the user selects the edit action button 1110. Selecting the edit action button 1110 brings up a screen that permits the user to select an action type, for example a hyperlink, a photo, etc., as explained later herein.

When the user clicks away from the edited section, the rectangle changes color, for example from red to green. When the user selects another section of the page to be edited, a new rectangle appears to allow the user to select this new section. The new rectangle is drawn in the color representing editing, for example red. The user can select an action type for the new area to be edited or the user can terminate editing by selecting the select mode 1106 radio button. The user can also delete any rectangle currently on the screen, for example rectangle 1104, by selecting the delete selection button 1114.

When the select mode radio button 1106 is selected, the user can select any rectangle on the page to be edited. Each rectangle represents a hot spot that is associated with one of the action types. When a hot spot is selected and the user then selects the edit action button 1110, a screen is displayed indicating the action type, for example a video, which is associated with the hotspot. If the user wishes, the user can change the action type, as explained later herein.

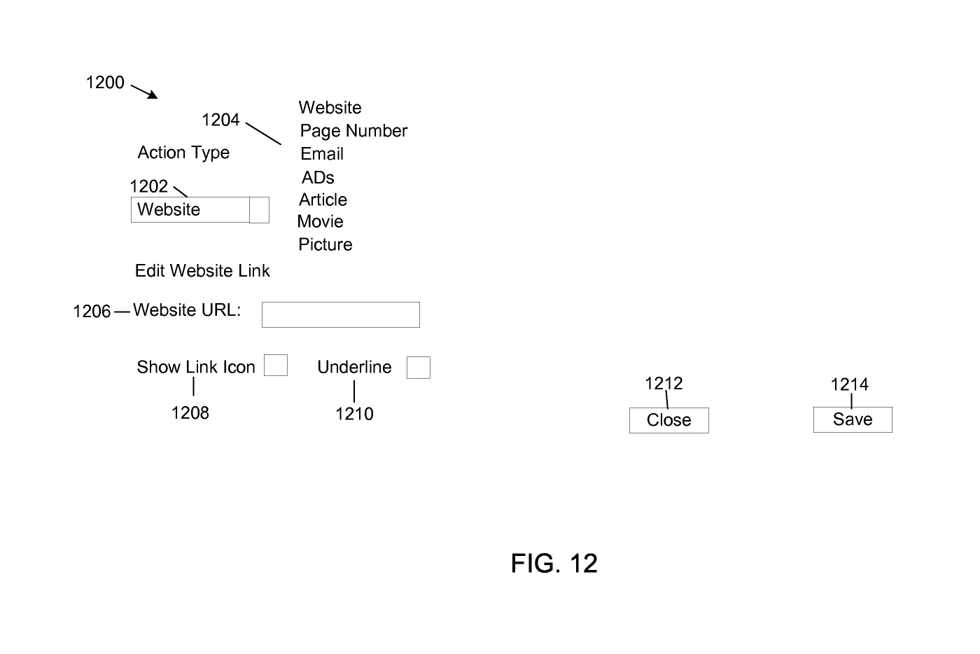

FIG. 12 shows an example action type screen 1200. The example action type screen 1200 is displayed when the edit action button 1110 is selected on the edit hotspots screen 1100. The action type screen 1200 includes an action type drop-down list box 1202 and, depending on an action type selected in the action type drop-down list box 1202, may also include a website URL text box 1206, a show link icon checkbox 1208 and an underline checkbox 1210. Action types 1204 that may be selected via the action type drop-down list box 1202 include a website, a page number, an email address, an advertisement, an article, a movie or a picture. Other action types are possible.

For example, when a website action type is selected, the action type screen 1200 displays the website URL text box 1206, the show link icon checkbox 1208 and the underline checkbox 1210. A URL of a website to be displayed is entered into the website URL text box 1206. In examples, an icon or an underline (hyperlink) may be associated with the section of text to which the website action type is being added. When an icon is associated with the section of text, the show link icon checkbox 1208 is checked. This causes an icon to appear next to the section of text, making it clear to a reader that an action type is associated with the section of text. When an underline (hyperlink) is associated with the section of text, the underline checkbox 1210 is checked. The causes the section of text to be underlined, indicating to a reader that a hyperlink is associated with the section of text.

Other action types result in the display of other controls on the action type screen 1200. For example, when an email action type is selected, the action type screen 1200 includes a textbox (similar to the website URL text box 1206) for entering an email address. When a picture action type is selected, the action type screen 1200 includes a textbox (not shown) for entering an identifier (typically a name) for the picture. The action type screen 1200 also includes a browse button (not shown) for locating the picture, typically on the client computer of the publisher, and for selecting the picture. When a movie action type is selected, in addition to a text box (not shown) for entering an identifier (typically a name) for the movie and a text box (not shown) for entering a URL specifying a location for the movie, the action type screen 1200 includes a video display control (not shown) in which the selected movie can be viewed. The action type screen 1200 includes similar types of controls for other action types. The action type screen 1200 also includes a close button 1212 for closing the action type screen 1200 and a save button 1214 for saving changes to the action type screen 1200.

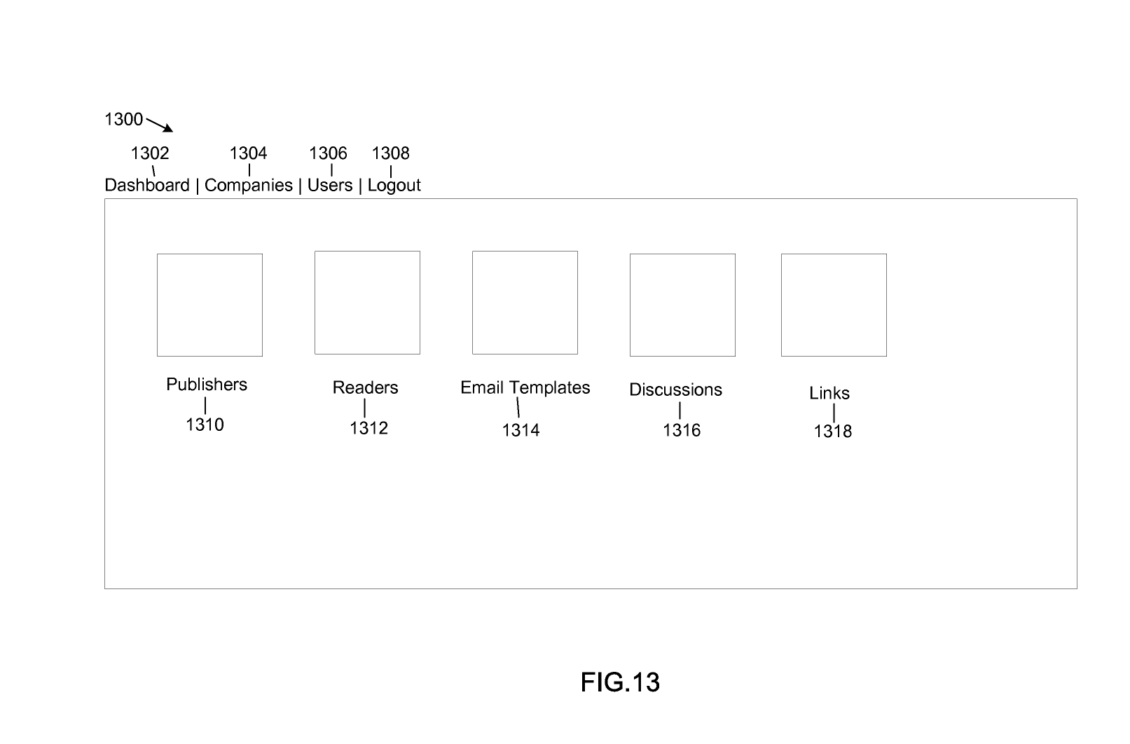

FIG. 13 shows an example portals screen 1300 rendered on a user device when the user accesses the portal website 112. The example portals screen 1300 includes a publishers icon 1310, a readers icon 1312, an email templates icon 1314, a discussions icon 1316 and a links icon 1318. The example publishers icon 1310 provides access to the publisher website 110. The example readers icon 1312 provides access to the reader website 108. The example email templates icon 1314 provides access to a user's inbox, where the user can view, compose and edit email messages and participate in social media activities such as starting or responding to a discussion group, viewing or creating events, viewing photos and videos, changing a profile for the user, etc. The example discussions icon 1316 provides access to a listing of available discussion categories. A user can start a discussion for a selected category or view and respond to other user entries for a selected category. The example links icon 1318 provides access to selected linked websites.

The example portals screen 1300 also includes tabs 1302-1308 for a dashboard, companies, users and logout, respectively. The portals screen 1300 as shown is displayed when the dashboard tab 1302 is selected. The portals screen 1300 with the dashboard tab selected is the default screen for the portal website 112. The companies tab 1304 displays a list of publishers and information about the publishers. The users tab 1306 displays a list of users (readers) and information about the users. The logout tab 1308 logs a user out of the portal website 112.

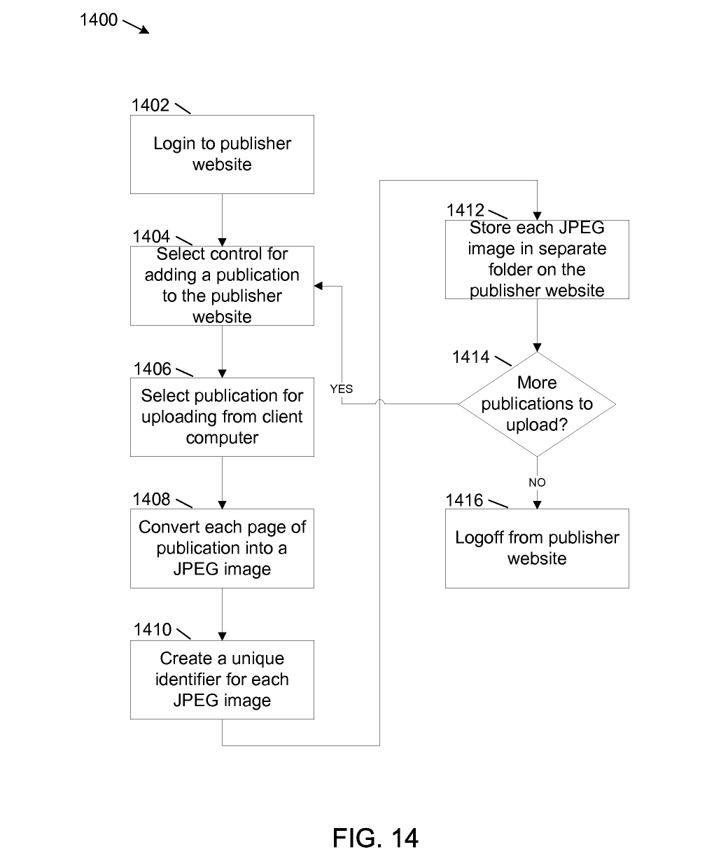

FIG. 14 shows a flowchart 1400 for a method for uploading a document to a publisher website, for example to publisher website 110. At operation 1402, a user, typically a publisher, logs in to the publisher website. At operation 1404, the user selects a control, for example the add-new button 822 from FIG. 8, to add a publication to the publisher website. At operation 1406, the user selects a publication, typically a newspaper, for uploading to the publisher website from a user device, typically a client computer or a mobile device. The publication for uploading is typically in the PDF format.

At operation 1408, each page of the document in the PDF formation is converted into a JPEG image. The conversion is typically performed via a dynamic link library (DLL) on the publisher website. In some examples, the DLL is a third party product. Converting each page of the document into a separate JPEG image permits efficient caching of the JPEG images and increases speed of data retrieval of the document on the reader website 108.

At operation 1410, a unique identifier is created for each JPEG image. In examples, the unique identifier is a database identifier for each JPEG image, typically a SQL identifier, for example <guid>.JPEG.

At operation 1412, each JPEG image is stored in a separate folder on the publisher website. Typically, each folder is a file system folder on a server computer that is part of the publisher website. However, other storage devices, for example a client computer, are possible. Storing each JPEG image in a file system permits local caching and faster retrieval than from a database.

At operation 1414, a determination is made as to whether there are more publications to upload. When a determination is made at operation 1414 that there are more publications to upload, control returns to operation 1404 and the add-new button 822 is selected again to upload a new publication to the publisher website 110. When a determination is made at operation 1414 that there are no more publications to upload, at operation 1416, the user logs off from the publisher website.

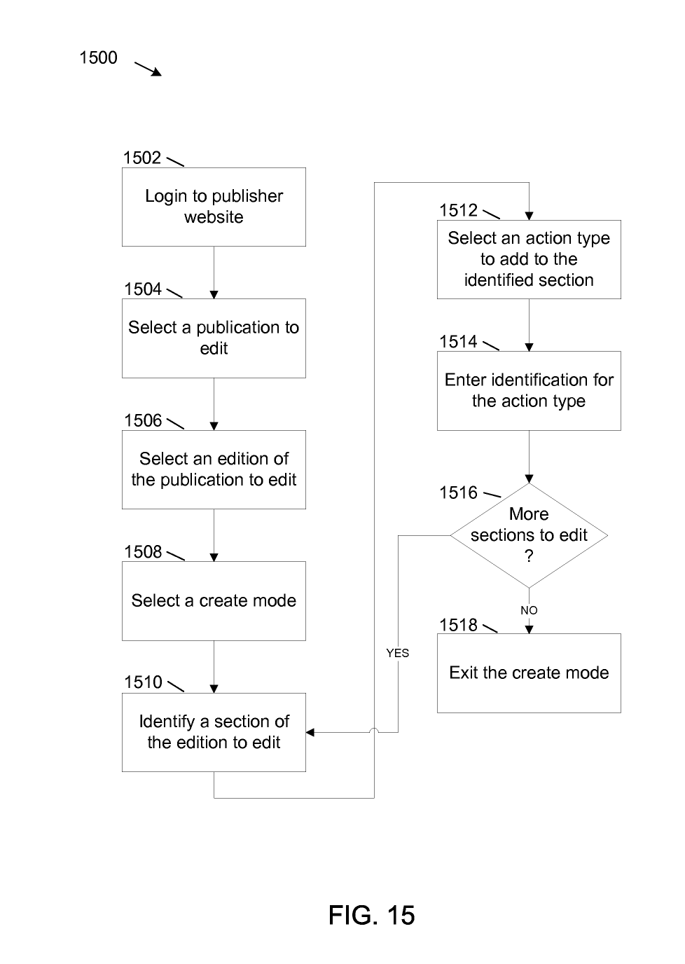

FIG. 15 shows a flowchart 1500 for a method for editing a document that has been uploaded to the publisher website, for example to publisher website 110. The editing of the document comprises selecting one or more sections of the document and adding an action type to the selected section. The action type provides an action effect, for example a photo, video, hyperlink, etc., to the section of the document. The action type may be accessed during viewing when the user selects the section of the document corresponding to the action type.

At operation 1502, a user, typically a publisher, logs in to a publisher website, for example publisher website 110. At operation 1504, the user selects a publication to edit. When the user selects the publication to edit uploaded editions of the publication are displayed. At operation 1506, the user selects an edition of the selected publication to edit.

At operation 1508, the user selects a create mode. In examples, the publisher website 110 includes a create mode and a select mode. The create mode is used to add action types to sections of a publication that currently do not have action types added. The select mode is used to view action types already added to sections of the publication and possibly select a different action type for the section of the publication.

At operation 1510, a section of the edition to be edited is identified. The section may be a word, a series of words, a paragraph, a photo, a table, etc.

At operation 1512, an action type is added to the identified section. The action type may be a website, a page number, an email template, an advertisement, an article, a movie or a picture. Other action types are possible. The action type creates an associated action for the section of the document. For example, if the identified section of the edition is a name of a person and the action type is a website, clicking a hyperlink assigned to the name of the person activates the website. The website may provide information regarding the person.

At operation 1516, a determination is made as to whether there are more sections of the edition to edit. When a determination is made at operation 1516 that there are more sections of the edition to which an action type is to be assigned, control returns to operation 1510 and a new section of the document is identified for editing. When a determination is made at operation 1516 that there are not any more sections of the addition to which an action type is be assigned, at operation 1518, the create mode is exited.

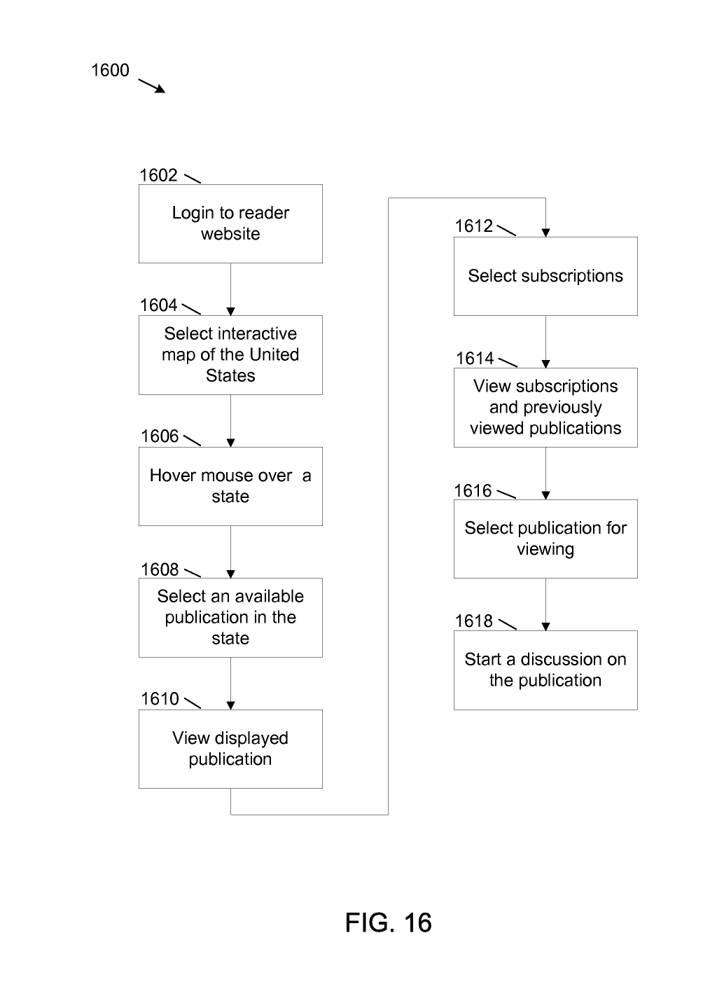

FIG. 16 shows a flowchart 1600 for a method for viewing a publication on a reader website, for example on reader website 108. At operation 1502, a user, typically a reader who wants to view publication content, logs in to a reader website, for example reader website 108.

At operation 1604, the user selects a control on the reader website 108 that displays an interactive map of the United States of America. The control is typically, a tab on the reader website 108, for example, the publications tab 502.

At operation 1606, the user hovers a mouse over a state on the map. If newspapers or other publications from the state are available for viewing, the available newspapers or other publications are displayed to the viewer when the mouse hovers over the state. The display indicates the name of the newspaper or other publication and whether the newspaper or other publication is free or requires a subscription.

At operation 1608, the user selects an available publication in the state. When the user selects the publication, at operation 1610, the publication is displayed to the viewer. The publication is displayed to the viewer on a client computer or on a mobile device. The user may view the publication page by page or the user may select specific pages via selecting a thumbnail icon corresponding to a page or by selecting a page from a table of contents displayed to the viewer.

At operation 1612, the viewer may select a control on the reader website 108 to display current subscriptions and previously viewed publications for the user. The control is typically a tab on the reader website, for example the subscriptions tab 504.

At operation 1614, the current subscriptions and previously viewed publications for the user are displayed. When the previously viewed publications are displayed, in examples, selections are available for a current edition and for previously viewed editions. At operation 1618, the user may select a publication for viewing.

At operation 1618, the user may click a control on the reader website 108 to start a discussion regarding the selected publication or to comment in an existing discussion thread.

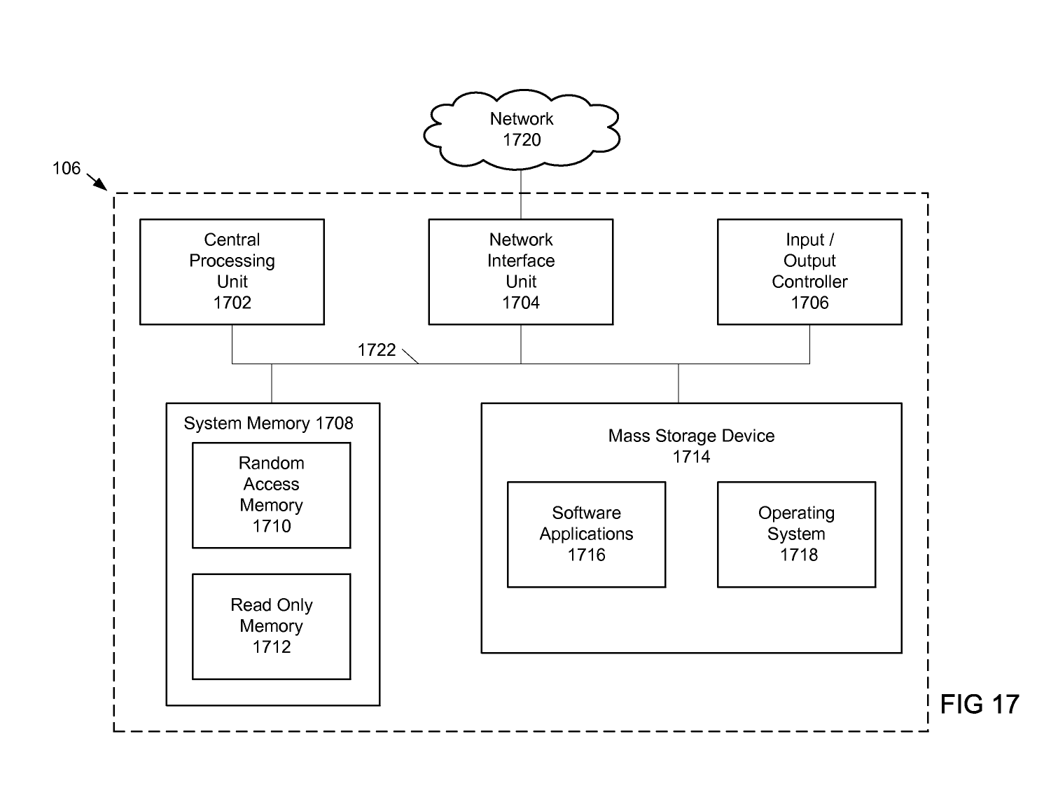

FIG. 17 illustrates example physical components of the web server computer 106. As illustrated in the example of FIG. 17, the web server computer 106 includes at least one central processing unit (“CPU”) 1702, a system memory 1708, and a system bus 1722 that couples the system memory 1708 to the CPU 1702. The system memory 1708 includes a random access memory (“RAM”) 1710 and a read-only memory (“ROM”) 1712. A basic input/output system contains the basic routines that help to transfer information between elements within the web server computer 106, such as during startup, is stored in the ROM 1712. The web server computer 106 further includes a mass storage device 1714. The mass storage device 1714 is able to store software instructions and data.

The mass storage device 1714 is connected to the CPU 1702 through a mass storage controller (not shown) connected to the system bus 1722. The mass storage device 1714 and its associated computer-readable data storage media provide non-volatile, non-transitory storage for the web server computer 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the web server computer 106.

According to various embodiments of the invention, the web server computer 106 may operate in a networked environment using logical connections to remote network devices through the network 1720, such as a local network, the Internet, or another type of network. The web server computer 106 may connect to the network 1720 through a network interface unit 1704 connected to the system bus 1722. It should be appreciated that the network interface unit 1704 may also be utilized to connect to other types of networks and remote computing systems. The web server computer 106 also includes an input/output controller 1706 for receiving and processing input from a number of other devices, including a keyboard, a mouse, a touch user interface display screen, or another type of input device. Similarly, the input/output controller 1706 may provide output to a touch user interface display screen, a printer, or other type of output device.

As mentioned briefly above, the mass storage device 1714 and the RAM 1710 of the web server computer 106 can store software instructions and data. The software instructions include an operating system 1718 suitable for controlling the operation of the web server computer 106. The mass storage device 1714 and/or the RAM 1710 also store software instructions, that when executed by the CPU 1702, cause the web server computer 106 to provide the functionality of the web server computer 106 discussed in this document. For example, the mass storage device 1714 and/or the RAM 1710 can store software instructions that, when executed by the CPU 1702, cause the web server computer 106 to display received physiological data on the display screen of the web server computer 106.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for providing a digital publication system, the method comprising:
on a first electronic computing device, receiving a first document from a second electronic computing device, the first document being in a first format and comprising a plurality of pages;
converting the first document from the first format to a second format, the conversion generating a separate document in the second format for each page of the first document;
storing each separate document in the second format in separate identifiable areas of memory of the first electronic computing device;
receiving a first request from the second electronic computing device to edit a first section of a page of the first document;
identifying one separate document in the second format corresponding to the page in the first format to be edited; and
adding an action type to the first section of the identified separate document.

2. The method of claim 1, further comprising:
receiving from a third electronic computing device a request for the first document;
determining the identifiable areas of memory for each of the separate documents that corresponds to the first document;
obtaining the separate documents from the identifiable areas of memory; and
sending the obtained separate documents to the third electronic computing device.

3. The method of claim 1, further comprising using a caching engine on the first electronic computing device to obtain the separate documents from the identifiable areas of memory.

4. The method of claim 1, wherein each identifiable area of memory is a file folder on the first electronic computing device and wherein each of the separate documents is stored in a separate file folder.

5. The method of claim 1, wherein converting the electronic document from the first format to the second format comprises using a dynamic link library (DLL) to convert each page of the electronic document in the first format to the separate document in the second format.

6. The method of claim 5, wherein the first electronic document is formatted in a Portable Document Format (PDF) format and wherein each separate document is formatted in a Joint Photographic Experts Group (JPEG) format.

7. The method of claim 6, wherein each separate document is formatted using a Hypertext Markup Language (HTML) 5 markup language.

8. The method of claim 1, wherein the action type creates an actionable effect when viewing the first section of the identified separate document.

9. The method of claim 1, wherein the action type is one of a hyperlink, a photo, a slide show, and advertisement and a video.

10. The method of claim 1, further comprising receiving social networking information from the third electronic computing device and making the social networking information available to a fourth electronic computing device.

11. The method of claim 1, further comprising:
receiving a log-in request from the third electronic computing device; and
after authenticating the log-in request, transmitting a reader user interface to the third electronic device, the reader user interface including an interactive map of a geographic area, the interactive map of the geographic area providing names of publications that are available in a plurality of areas of the geographic area.

12. The method of claim 1, further comprising:
receiving a log-in request from the second electronic computing device; and
after authenticating the log-in request, transmitting a publisher user interface to the second electronic computing device, the publisher user interface including a list of publications available for editing on the first electronic computing device.

13. The method of claim 1, wherein each of the separate documents comprises content of a newspaper page, at least some of the separate documents including text, photographs and advertisements in a format of the newspaper page.

14. A first electronic computing device comprising:
a processing unit; and
system memory, the system memory including instructions that when executed by the processing unit cause the first electronic computing device to:
receive a first document from a second electronic computing device, the first document being in a first format and comprising a plurality of pages;
convert the first document from the first format to a second format, the conversion generating a separate document in the second format for each page of the first document;
store each separate document in the second format in separate identifiable areas of memory of the first electronic computing device;
receive a first request from the second electronic computing device to edit a first section of a page of the first document;
identify the separate document in the second format corresponding to the page in the first format to be edited; and
add an action type to the first section of the identified separate document.

15. The computing device of claim 14, further comprising:
receive from a third electronic computing device a request for the first document;
determine the identifiable areas of memory for each of the separate documents that corresponds to the first document;
obtain the separate documents from the identifiable areas of memory; and
send the obtained separate documents to the third electronic computing device.

16. The computing device of claim 14, further comprising using a caching engine on the first electronic computing device to obtain the separate documents from the identifiable areas of memory.

17. The computing device of claim 14, wherein each identifiable area of memory is a file folder on the first electronic computing device and wherein each of the separate documents is stored in a separate file folder.

18. The computing device of claim 14, wherein the action type creates an actionable effect when viewing the first section of the identified separate document.

19. The computing device of claim 14, wherein each of the separate documents comprises content of a newspaper page, at least some of the separate documents including text, photographs and advertisements in a format of the newspaper page.

20. A computer-readable data storage medium comprising instructions that, when executed by a processing unit of a first electronic computing device, cause the first electronic computing device to:
receive a first document from a second electronic computing device, the first document being in a first format and comprising a plurality of pages, the first format being a Portable Document Format (PDF);
convert the first document from the first format to a second format, the second format being a Joint Photographic Experts Group (JPEG) format, the conversion generating a separate document in the second format for each page of the first document, each separate document being formatted using a Hypertext Markup Language (HTML) 5 markup language;
store each separate document in the second format in a separate identifiable file folder of the first electronic computing device;
receive a log-in request to the first electronic computing device from the second electronic computing device;
transmit a publisher user interface to the second electronic computing device, the publisher user interface including a list of publications available for editing on the first electronic computing device;
receive a first request from the second electronic computing device to edit a first section of a page of the first document;
identify the separate document in the second format corresponding to the page in the first format to be edited;
add an action type to the first section of the identified separate document, the action type creating an actionable effect on the first section of the identified separate document, the action type being one of a hyperlink, a photo, a slide show, and advertisement and a video;
receive a log-in request to the first electronic computing device from a third electronic computing device;
transmit a reader user interface to the third electronic device, the reader user interface including an interactive map of a geographic area, the interactive map of the geographic area providing names of publications that are available in a plurality of sub-areas of the geographic area;
receive from the third electronic computing device a request for the first document;
determine the identifiable file folder for each of the separate documents that corresponds to the first document;
use a caching engine to obtain the separate documents from the identifiable file folders, the caching engine comprising a web service;
send the obtained separate documents to the third electronic computing device;
receive social networking information from the third electronic computing device;
store the social networking information on the first electronic computing device;
receive a request for the social networking information from a fourth electronic computing device; and
send the social networking information to the fourth electronic computing device.
